(19) United States
(12) Patent Application Publication
(10) Pub. No.: US 2018/0330320 A1
(43) Pub. Date: Nov. 15, 2018

(54) METHOD AND SYSTEM FOR REAL-TIME UPDATE, TRACKING, AND NOTIFICATION OF PACKAGE DELIVERY

(71) Applicant: Mastercard International Incorporated, Purchase, NY (US)

(72) Inventor: Manoneet KOHLI, O'Fallon, MO (US)

(73) Assignee: Mastercard International Incorporated, Purchase, NY (US)

(21) Appl. No.: 15/593,784

(22) Filed: May 12, 2017

(51) Int. Cl. G06Q 10/08

(52) U.S. Cl. CPC G06Q 10/0833

(57) ABSTRACT

A method for package delivery notification includes: storing a predetermined distance and a time interval; receiving a first device identifier of a first computing device associated with purchase of a product for delivery; receiving a second device identifier of a second computing device associated with delivery of the product; receiving a first location notification including the first device identifier and a first geographic location, and a second location notification including the second device identifier and a second geographic location; calculating a distance between the first geographic location and the second geographic location; and repeating receipt of the first location notification and second location notification after subsequent time intervals if the calculated distance is greater than the predetermined distance, or transmitting a notification message to the first computing device indicating that the product is within the predetermined distance of the first computing device.

### FIELD

The present disclosure relates to the updating, tracking, and notification of package delivery in real-time, specifically the use of geographic locations of associated computing devices for the recipient and the courier of a package to increase efficiency in package delivery.

### BACKGROUND

As Internet and other forms of remote shopping increase in usage by consumers, the number of packages that are delivered throughout the world also increases. As a result, package delivery services have made efforts to increase their capacity to deliver packages to consumers. For instance, many services utilize longer hours and additional days in order to increase the number of packages that they can deliver, to account for increases in the number of packages ordered.

However, an increase in capacity without an increase in efficiency may limit delivery services' ability to satisfy the needs of all of their customers. One way many services attempt to increase efficiency is to map more effective routes for delivery once packages have been received by the delivery service. However, such routes are based purely on the stated delivery address provided for the package, and also can only be identified for packages that are received ahead of the mapping of the route, which may not be the case for packages received for same- or next-day delivery, or for instances where the delivery address for a package is modified near the delivery time.

Thus, there is a need for a technical solution to increase the efficiency of package delivery that can account for changes and updates in delivery location and location of the package prior to delivery in real-time, to remedy the deficiencies of current package delivery solutions.

### SUMMARY

The present disclosure provides a description of systems and methods for notification of package delivery. Geographic locations of devices associated with the recipient of a package as well as the courier of a package are obtained at predetermined time intervals. When the two locations come within a predetermined distance from one another, the recipient, and, optionally, the courier, are notified. In cases where the recipient is not at the stated delivery location for the package, the recipient may be able to request that the package be delivered to their current location. For instance, the recipient may be at work and the courier may be passing by the recipient's workplace when delivering another package, where the recipient's request may enable the courier to stop by the workplace and deliver the package early. The result may be an increase in delivery efficiency as well as additional convenience for the recipient.

A method for package delivery notification includes: storing, in a memory of a processing server, a predetermined distance and a time interval; receiving, by a receiving device of the processing server, a first device identifier of a first computing device associated with purchase of a product for delivery; receiving, by the receiving device of the processing server, a second device identifier of a second computing device associated with delivery of the product; receiving, by the receiving device of the processing server after the time interval, a first location notification including at least the first device identifier and a first geographic location, and a second location notification including at least the second device identifier and a second geographic location; calculating, by a calculation module of the processing server, a distance between the first geographic location and the second geographic location; and repeating receipt of the first location notification and second location notification after subsequent time intervals if the calculated distance is greater than the predetermined distance, or electronically transmitting, by a transmitting device of the processing server, a notification message to the first computing device indicating that the product is within the predetermined distance of the first computing device.

A system for package delivery notification includes: a transmitting device of a processing server; a calculation module of the processing server; a memory of the processing server configured to store a predetermined distance and a time interval; and a receiving device of the processing server configured to receive a first device identifier of a first computing device associated with purchase of a product for delivery, and a second device identifier of a second computing device associated with delivery of the product, wherein the receiving device of the processing server is further configured to receive, after the time interval, a first location notification including at least the first device identifier and a first geographic location, and a second location notification including at least the second device identifier and a second geographic location, the calculation module of the processing server is configured to calculate, after the time interval, a distance between the first geographic location and the second geographic location, and the receiving device and the calculation module are further configured to repeat receipt of the first location notification and second location notification and calculation of the distance after subsequent time intervals if the calculated distance is greater than the predetermined distance, or the transmitting device of the processing server is configured to electronically transmit a notification message to the first computing device indicating that the product is within the predetermined distance of the first computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for increasing efficiency and convenience in package delivery in accordance with exemplary embodiments.

FIG. 2 is a block diagram illustrating a processing server for use in the system of FIG. 1 for increasing efficiency in package delivery in accordance with exemplary embodiments.

FIG. 3 is a flow diagram illustrating a process for notification and updating of package delivery in real-time using the processing server of FIG. 2 in accordance with exemplary embodiments.

FIG. 4 is a diagram illustrating the distribution of real-time notifications for package delivery based on geographic location in the system of FIG. 1 in accordance with exemplary embodiments.

FIG. 5 is a flow chart illustrating an exemplary method for package delivery notification in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

### System for Real-Time Update and Notification for Package Delivery

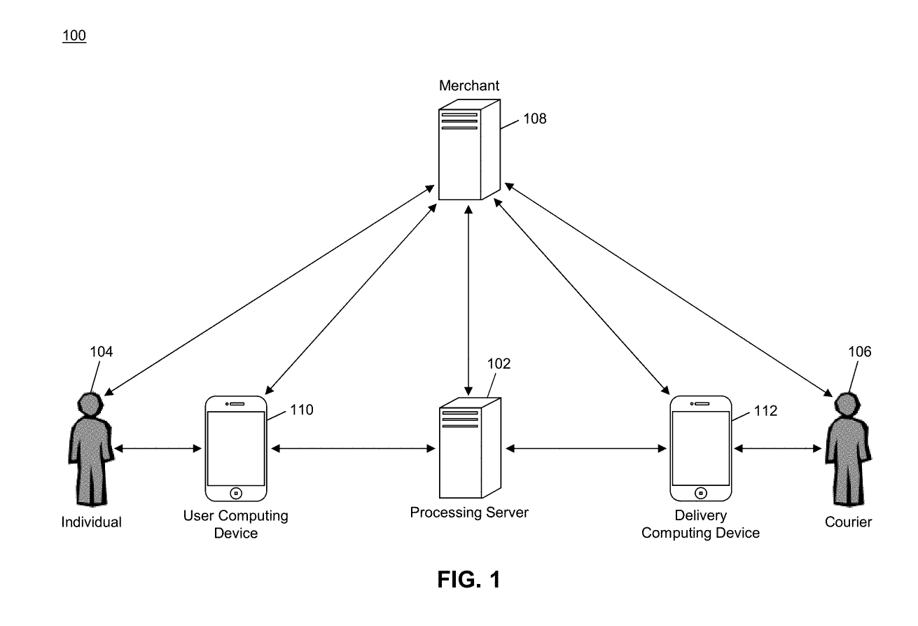

FIG. 1 illustrates a system 100 for the real-time updating and notification of package delivery based on geographic locations of recipient and courier devices.

The system 100 may include a processing server 102. The processing server 102, discussed in more detail below, may be configured to provide for real-time updates in the delivery of a package to an individual 104 from a courier 106, including the providing of notifications to the individual 104 when the courier 106 is within a predetermined distance of the individual 104, which may be identified regardless of the stated delivery address for a package. In the system 100, the individual 104 may order a package from a merchant 108. For instance, the individual 104 may conduct an e-commerce transaction at a website or via an application program of the merchant 108, an in-person transaction where one or more selected products are purchased that must be shipped, etc.

The individual 104 may register a user computing device 110 with the processing server 102 to receive real-time updates and notifications regarding delivery of their package by the courier 106. In some embodiments, the individual 104 may register the user computing device 110 directly with the processing server 102, such as by providing a device identifier associated with the user computing device 110 to the processing server 102 via a suitable interface (e.g., an application program, short messaging service message, e-mail, website, etc.). In other embodiments, the individual 104 may provide the device identifier for the user computing device 110 to the merchant 108 while conducting the payment transaction for purchase of the product(s). In such embodiments, the merchant 108 may provide the device identifier directly to the processing server 102, or may provide the device identifier to the courier 106 (e.g., or an entity for which the courier 106 operates, such as a delivery service entity), which may relay the device identifier to the processing server 102. The processing server 102 may then associate the device identifier with the delivery of a particular package, which may be identified by the courier 106. The device identifier may be a unique value associated with a computing device used for identification thereof, such as a media access control address, registration number, serial number, identification number, telephone number, e-mail address, username, etc.

The processing server 102 may also receive a device identifier for a delivery computing device 112 associated with the courier 106. The delivery computing device 112 may be any type of computing device that may be used or possessed or otherwise located in proximity of the courier 106 during delivery of the package, such as a handheld scanning device used to scan machine-readable codes on packages used for tracking, inventory, and other traditional practices. In some cases, the processing server 102 may further receive a unique identification value for a package, which may be used to associate the user computing device 110 to the delivery computing device 112. In some instances, the processing server 102 may also receive a delivery address for the package, which may be the address provided by the individual 104 to the merchant 108 where the package is to be delivered, which may be relayed to the processing server 102 by the individual 104, merchant 108, or courier 106.

The processing server 102 may be configured to receive geographic location notifications. The processing server 102 may receive geographic location notifications for the user computing device 110 and geographic location notifications for the delivery computing device 112. In some embodiments, the geographic location notifications may be electronically transmitted directly from the corresponding computing devices. In other embodiments, the geographic location notifications may be electronically transmitted to the processing server 102 via a third party system, such as a mobile network operator associated with each respective computing device. The geographic location of a computing device may be identified using any suitable method, such as cellular network triangulation, global positioning system, area network identification, etc. In some cases, each computing device may be configured to identify its own geographic location. In other cases, another entity or system (e.g., the associated mobile network operator) may identify the geographic location of a computing device, which may be then reported to the respective computing device and/or to the processing server 102.

The processing server 102 may receive a first location notification, which may include the device identifier and a geographic location for the user computing device 110, and may receive a second location notification, which may include the device identifier and a geographic location for the delivery computing device 112. If the geographic locations are within a predetermined distance of one another, the processing server 102 may be configured to notify the individual 104 via the user computing device 110, such as by electronically transmitting a notification to the user computing device 110, such as via e-mail, short messaging service message, an application program executed by the computing device 110, etc. The individual 104 may thus be notified that the courier 106 is near their current location. The predetermined distance may be predetermined by the processing server 102, or may be set by the individual 104 and/or courier 106, such as during the registration process for delivery of the package. In some instances, the processing server 102 may also electronically transmit a notification to the courier 106 (e.g., via the delivery computing device 112) indicating that the courier 106 is within the predetermined distance of the individual's registered user computing device 110. If the geographic locations are not within a predetermined distance, the processing server 102 may wait and receive updated geographic locations after a time interval, where the time interval may be identified by the processing server 102, individual 104, courier 106, or merchant 108, and may be based on feedback received from individuals 104 and couriers 106 regarding usage of the system 100.

In some embodiments, the individual 104 may be provided with an opportunity to request immediate delivery of the package. In some such embodiments, such an opportunity may only be provided if the individual 104 is not located (e.g., based on the location of the user computing device 110) at or near (e.g., within a predetermined distance, which may be a different predetermined distance) the registered delivery address for the package. The individual 104 may request immediate delivery of the package by responding to the notification and indicating accordingly, such as by returning a short messaging service message back to the processing server 102 indicating they want the package to be delivered to their current location. The processing server 102 may then notify the courier 106 (e.g., via the delivery computing device 112) of the change in delivery address and provide the courier 106 with the geographic location of the user computing device 110. The courier 106 may then deliver the package to the individual 104 at that location.

As a result, the efficiency of package delivery may be increased. For instance, the individual 104 may be at a significantly different location than the registered delivery location, where the location may be very close to another delivery being made by the courier 106, so that the courier 106 can stop by the individual 104 and not have to travel to the registered delivery location later, decreasing the time it will take the courier 106 to make all of their deliveries, thus increasing efficiency and capacity. In addition, it may provide greater convenience to the individual 104, who may receive their package more quickly than in existing systems. As a result, the processing server 102 provides a technical improvement over existing systems by providing updates in real-time regarding package and delivery location and enabling delivery locations to be modified based on current locations.

### Processing Server

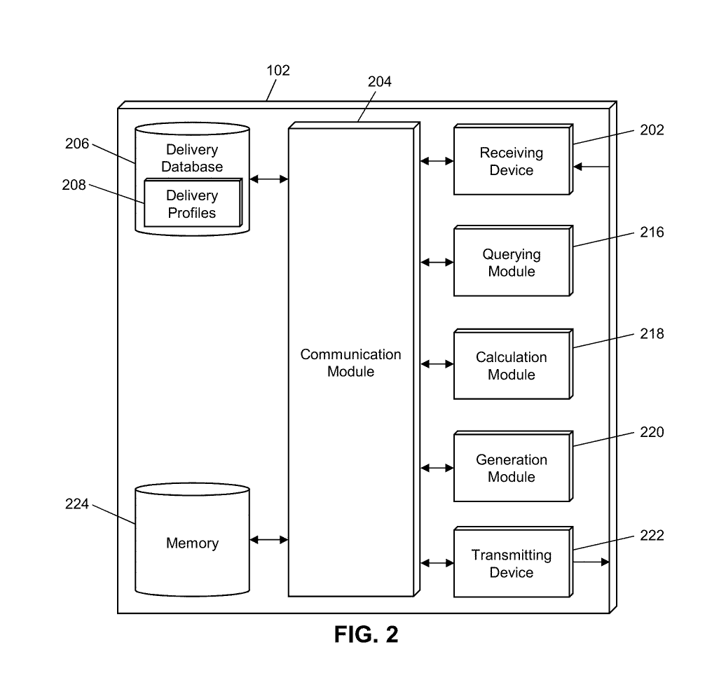

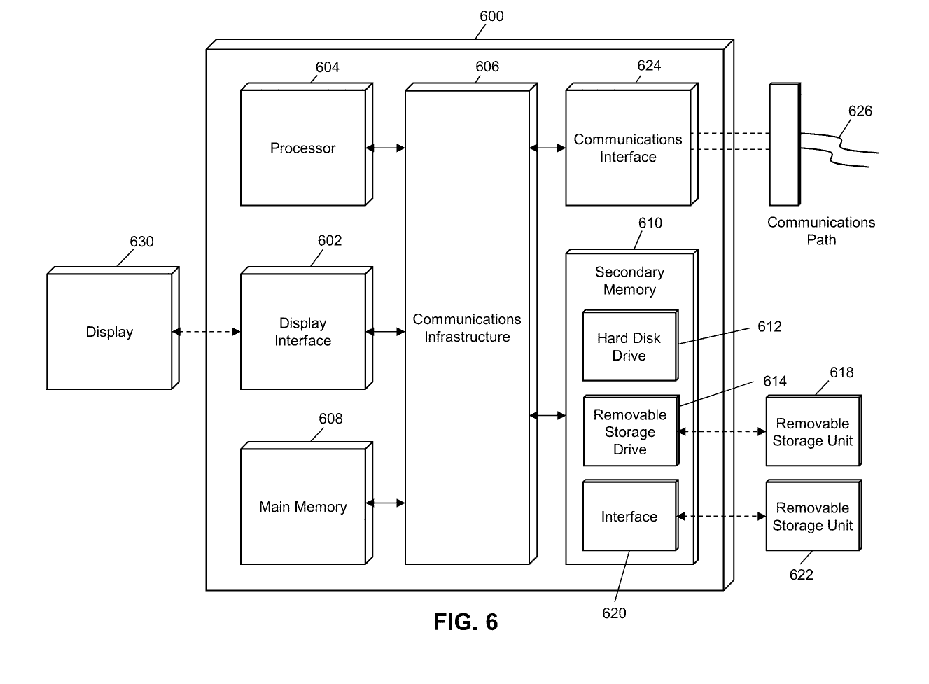

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from merchants 108, user computing devices 110, delivery computing devices 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals that are superimposed or may be otherwise encoded with a device identifier associated with the user computing device 110, which may be electronically transmitted by the user computing device 110, delivery computing device 112, or merchant 108. The receiving device 202 may also be configured to receive data signals superimposed or otherwise encoded with a device identifier associated with the delivery computing device 112, which may be electronically transmitted by the merchant 108 or delivery computing device 112. The receiving device 202 may be further configured to receive data signals superimposed or otherwise encoded with location notifications, which may include a geographic location and device identifier for a computing device, and may be received directly from the respective computing device or from a third party entity or system. The receiving device 202 may also be configured to receive delivery update notifications, which may be electronically transmitted by user computing devices 110 and include indications to update the delivery location for a package, and may also include the updated delivery location.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 216, calculaton module 218, generation module 220, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a delivery database 206. The delivery database 206 may be configured to store a plurality of delivery profiles 208 using a suitable data storage format and schema. The delivery database 206 may be a relational database that utilizes structured query language for the storage, identification, modifying, updating, accessing, etc. of structured data sets stored therein. Each delivery profile 208 may be a structured data set configured to store data related to a package delivery, and may include at least a device identifier associated with a user computing device 110, a device identifier associated with a delivery computing device 112, and a delivery location. In some cases, a delivery profile 208 may further include communication data for contacting the computing devices, a registered delivery address, and other data for using the methods and systems discussed herein, such as a customized predetermined distance and/or time interval, such as may be provided by the individual 104. In some instances, the delivery profile 208 may include a unique identification value for the related package, and geographic locations received for each of the computing devices.

The processing server 102 may include a querying module 216. The querying module 216 may be configured to execute queries on databases to identify information. The querying module 216 may receive one or more data values or query strings, and may execute a query string based thereon on an indicated database, such as the delivery database 206, to identify information stored therein. The querying module 216 may then output the identified information to an appropriate engine or module of the processing server 102 as necessary. The querying module 216 may, for example, execute a query on the delivery database 206 to identify a delivery profile 208 corresponding to a received updated delivery notification for updating of the registered delivery location included therein.

The processing server 102 may also include a calculation module 218. The calculation module 218 may be configured to perform calculations for the processing server 102 as discussed herein. The calculation module 218 may receive instructions for a calculation as input, may perform the calculation, and may output the result of the calculation to another module or engine of the processing server 102. In some cases, the input may include data to be used in the calculation. In other cases, the calculation module 218 may be configured to identify data for use in the calculation. In an example, the calculation module 218 may be configured to calculate the distance between two geographic locations for computing devices received by the processing server 102, to determine if the distance is less than a predetermined distance.

The processing server 102 may also include a generation module 220. The generation module 220 may be configured to generate data for use in performing the functions of the processing server 102 as discussed herein. The generation module 220 may receive an instruction as input, may generate data as instructed, and may output the generated data to another module or engine of the processing server 102. For example, the generation module 220 may be configured to generate location notifications for electronic transmission to user computing devices 110 and delivery computing devices 112, which may include notifications that the courier 106 is located near the individual 104 or may include notifications that a delivery address has been updated based on the location of the individual 104.

The processing server 102 may also include a transmitting device 222. The transmitting device 222 may be configured to transmit data over one or more networks via one or more network protocols. In some instances, the transmitting device 222 may be configured to transmit data to user computing devices 110, delivery computing devices 112, and other entities via one or more communication methods, local area networks, wireless area networks, cellular communication, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals to user computing devices 110, which may be superimposed or otherwise encoded with notification messages, which may indicate that a courier 106 is within a predetermined distance of the device's last reported location. The transmitting device 222 may also be configured to electronically transmit data signals to delivery computing devices 112, which may be superimposed or otherwise encoded with delivery update notifications, which may include an updated delivery address for a package, and may also include an identification value for the package for use by the courier 106 in identification thereof.

The processing server 102 may also include a memory 224. The memory 224 may be configured to store data for use by the processing server 102 in performing the functions discussed herein, such as public and private keys, symmetric keys, etc. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 224 may be comprised of or may otherwise include a relational database that utilizes structured query language for the storage, identification, modifying, updating, accessing, etc. of structured data sets stored therein. The memory 224 may be configured to store, for example, predetermined distances, time intervals, distance calculation algorithms, etc.

### Process for Real-Time Package Notification and Updating

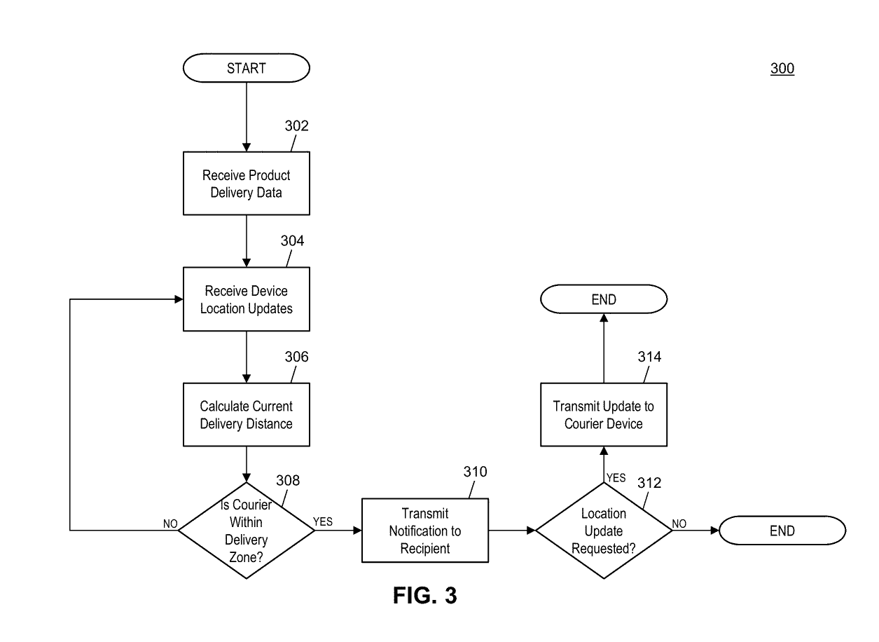

FIG. 3 illustrates a process 300 executed by the processing server 102 of the system 100 for the real-time notification of package location and updating for delivery thereof.

In step 302, the receiving device 202 of the processing server 102 may receive data associated with a product delivery. The data may include at least a first device identifier associated with a user computing device 110 and a second device identifier associated with a delivery computing device 112. In some instances, the data may also include a package identifier and may further include a registered delivery location. In step 304, the receiving device 202 may receive location updates. The location updates may include a first location notification that includes the first device identifier and a geographic location of the associated user computing device 110, and a second location notification that includes the second device identifier and a geographic location of the associated delivery computing device 112. In some instances, the first location notification may be received from the user computing device 110 and the second location notification may be received from the delivery computing device 112.

In step 306, the calculation module 218 of the processing server 102 may calculate the current delivery distance based on the distance between the geographic location of the user computing device 110 and the geographic location of the delivery computing device 112. In step 308, the processing server 102 may determine if the courier 106 is within the delivery zone of the individual 104. The courier 106 may be in the delivery zone if the calculated delivery distance is less than a predetermined distance. In some cases, the delivery zone may also include an area within the predetermined distance of the registered delivery location. If the courier 106 is not within the delivery zone, then the process 300 may return to step 304 and await receipt of updated geographic locations.

If the courier 106 is within the delivery zone, then, in step 310, the transmitting device 222 may electronically transmit a notification to the user computing device 110 associated with the individual 104 based on the first device identifier, where the notification indicates that the package is within the predetermined distance of the user computing device 110 (e.g., or the registered delivery location, if applicable). In step 312, the processing server 102 may determine if an update to the delivery location is requested. The determination may be based on if an electronic transmission is received by the receiving device 202 from the user computing device 110 that includes a delivery update request, which may include an updated delivery location or an indication to use the last location reported by the user computing device 110. If no location update is requested, then the process 300 may be completed as the individual 104 may await delivery to the registered delivery location. If a location update is requested, then, in step 314, the transmitting device 222 may electronically transmit an update to the delivery computing device 112 that may include the updated delivery location or the last location reported by the user computing device 110, as applicable.

### Real-Time Updating of Package Delivery

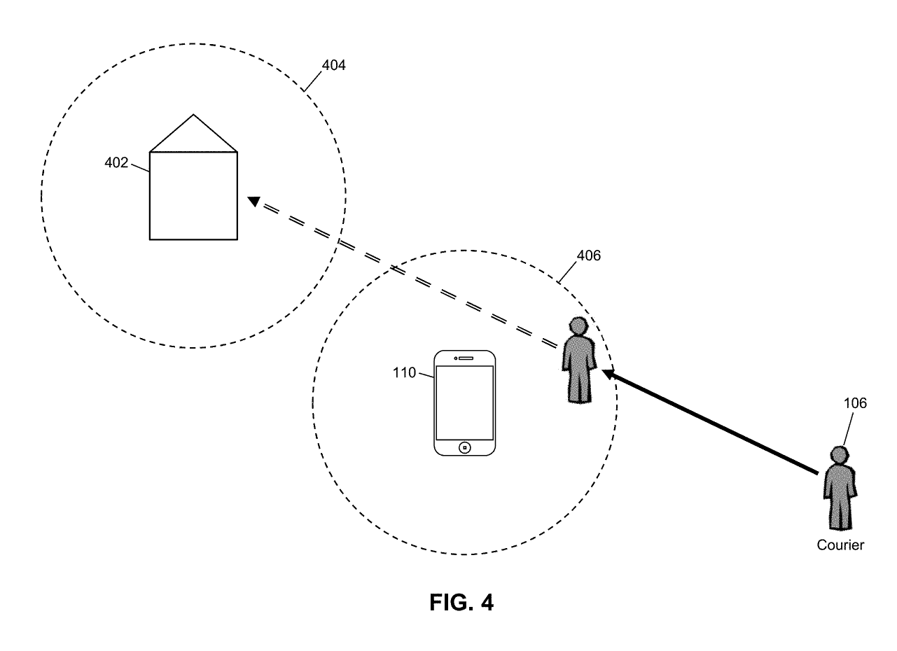

FIG. 4 illustrates the updating of the geographic location of a package to be delivered in the system 100 based on the location of the courier 106 and the geographic location of the individual 104 during the delivery.

As illustrated in FIG. 4, the courier 106 may have a package to be delivered to a registered delivery location 402, such as the shipping address provided by the individual 104 when purchasing a product included in the package. A registered delivery zone 404 may be identified based on the registered delivery location 402 and may be comprised of the area within a predetermined distance of the registered delivery location 402.

As part of the registration process for the delivery, the processing server 102 may receive the device identifier corresponding to the user computing device 110 associated with the individual 104 to whom the package is to be delivered. The geographic location of the user computing device 110 may be reported to the processing server 102, which may be used to determine an alternative delivery zone 406. The alternative delivery zone 406 may be comprised of the area within the predetermined distance of the reported geographic location of the user computing device 110.

In the illustrated example, the courier 106 may travel from their starting location towards the registered delivery location 402 to deliver the package. During their travel, the courier 106 may pass through the alternative delivery zone 406. The processing server 102 may identify the geographic locations of the user computing device 110 and the courier 106 (e.g., via their associated delivery computing device 112) and identify when the courier 106 has entered the alternative delivery zone 406. When the courier 106 enters, as illustrated in FIG. 4, the processing server 102 may then electronically transmit a notification to the user computing device 110 indicating that the courier 106 has entered the alternative delivery zone 406. The individual 104 may then feel free to request that the package is delivered to their current geographic location, which may result in faster receipt of the package, and increased efficiency for the courier 106 by saving them considerable time and traveling distance to deliver the package.

### Exemplary Method for Package Delivery Notification

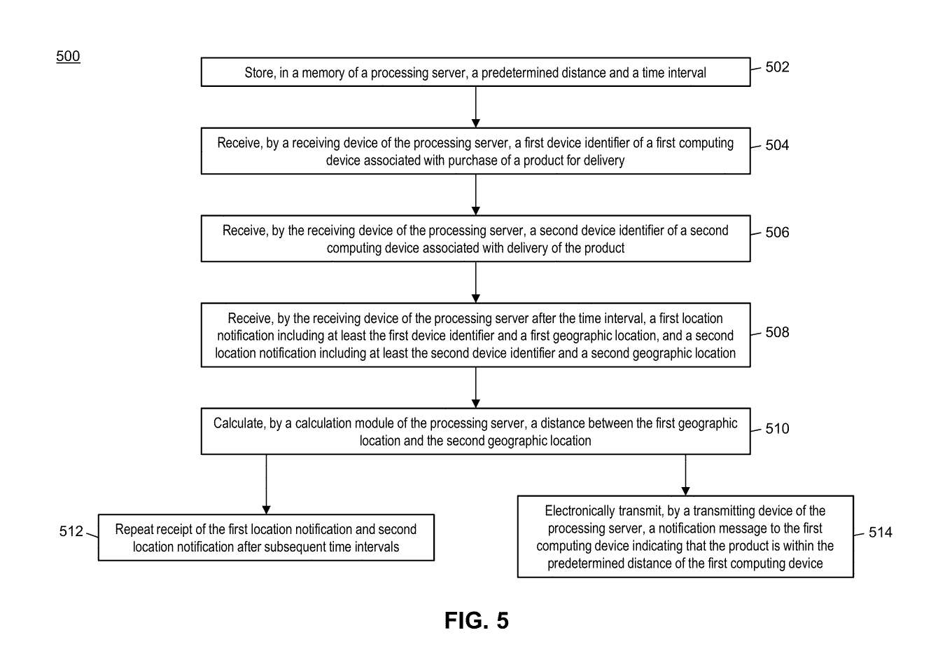

FIG. 5 illustrates a method 500 for the notification of a package delivery based on geographic locations of computing devices associated with delivery and receipt of the package.

In step 502, a predetermined distance and a time interval may be stored in a memory (e.g., the memory 224) of a processing server (e.g., the processing server 102). In step 504, a first device identifier of a first computing device (e.g., the user computing device 110) associated with purchase of a product for delivery may be received by a receiving device (e.g., the receiving device 202) of the processing server. In step 506, a second device identifier of a second computing device (e.g., the delivery computing device 112) associated with delivery of the product may be received by the receiving device of the processing server.

In step 508, the receiving device of the processing server may receive a first location notification including at least the first device identifier and a first geographic location, and a second location notification including at least the second device identifier and a second geographic location. In step 510, a distance may be calculated by a calculation module (e.g., the calculation module 218) of the processing server, where the distance may be a distance between the first geographic location and the second geographic location. If the calculated distance is greater than the predetermined distance, then, in step 512, the receipt of the first location notification and the second location notification may be repeated after subsequent time intervals. If the calculated distance is within the predetermined distance, then, in step 514, a notification message may be electronically transmitted by a transmitting device (e.g., the transmitting device 222) of the processing server to the first computing device indicating that the product is within the predetermined distance of the first computing device.

In one embodiment, the first location notification may be received from the first computing device and the second location notification may be received from the second computing device. In some embodiments, the method 500 may further include storing, in the memory of the processing server, a delivery location. In a further embodiment, the method 500 may also include: calculating, by the calculation module of the processing server after each time interval, a distance between the delivery location and the second geographic location, wherein receipt of the first location notification and second location notification after subsequent time intervals is repeated if the calculated distance between the first geographic location and the second geographic location and the calculated distance between the delivery location and the second geographic location is greater than the predetermined distance, and the notification message indicates that the product is within the predetermined distance of the delivery location if the calculated distance between the delivery location and the second geographic location is less than the calculated distance between the first geographic location and the second geographic location.

In another further embodiment, the method 500 may even further include: executing, by a querying module (e.g., the querying module 216) of the processing server, a query on the memory to update the delivery location with an updated delivery address; and electronically transmitting, by the transmitting device of the processing server, an update message to the second computing device, wherein the update message includes the updated delivery address. In an even further embodiment, the updated delivery address may be the first geographic location. In another even further embodiment, the method 500 may yet further include receiving, by the receiving device of the processing server, a location update notification from the first computing device, wherein the location update notification includes the updated delivery address.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for package delivery notifications. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for package delivery notification, comprising:
storing, in a memory of a processing server, a predetermined distance and a time interval;
receiving, by a receiving device of the processing server, a first device identifier of a first computing device associated with purchase of a product for delivery;
receiving, by the receiving device of the processing server, a second device identifier of a second computing device associated with delivery of the product;
receiving, by the receiving device of the processing server after the time interval, a first location notification including at least the first device identifier and a first geographic location, and
a second location notification including at least the second device identifier and a second geographic location;
calculating, by a calculation module of the processing server, a distance between the first geographic location and the second geographic location; and
repeating receipt of the first location notification and second location notification after subsequent time intervals if the calculated distance is greater than the predetermined distance, or
electronically transmitting, by a transmitting device of the processing server, a notification message to the first computing device indicating that the product is within the predetermined distance of the first computing device.

2. The method of claim 1, further comprising:
storing, in the memory of the processing server, a delivery location.

3. The method of claim 2, further comprising:
executing, by a querying module of the processing server, a query on the memory to update the delivery location with an updated delivery address; and
electronically transmitting, by the transmitting device of the processing server, an update message to the second computing device, wherein the update message includes the updated delivery address.

4. The method of claim 3, wherein the updated delivery address is the first geographic location.

5. The method of claim 3, further comprising:
receiving, by the receiving device of the processing server, a location update notification from the first computing device, wherein the location update notification includes the updated delivery address.

6. The method of claim 2, further comprising:
calculating, by the calculation module of the processing server after each time interval, a distance between the delivery location and the second geographic location, wherein
receipt of the first location notification and second location notification after subsequent time intervals is repeated if the calculated distance between the first geographic location and the second geographic location and the calculated distance between the delivery location and the second geographic location is greater than the predetermined distance, and
the notification message indicates that the product is within the predetermined distance of the delivery location if the calculated distance between the delivery location and the second geographic location is less than the calculated distance between the first geographic location and the second geographic location.

7. The method of claim 1, wherein
the first location notification is received from the first computing device, and
the second location notification is received from the second computing device.

8. A system for package delivery notification, comprising:
a transmitting device of a processing server;
a calculation module of the processing server;
a memory of the processing server configured to store a predetermined distance and a time interval; and
a receiving device of the processing server configured to receive
a first device identifier of a first computing device associated with purchase of a product for delivery, and
a second device identifier of a second computing device associated with delivery of the product, wherein
the receiving device of the processing server is further configured to receive, after the time interval,
a first location notification including at least the first device identifier and a first geographic location, and
a second location notification including at least the second device identifier and a second geographic location,
the calculation module of the processing server is configured to calculate, after the time interval, a distance between the first geographic location and the second geographic location, and
the receiving device and the calculation module are further configured to repeat receipt of the first location notification and second location notification and calculation of the distance after subsequent time intervals if the calculated distance is greater than the predetermined distance, or
the transmitting device of the processing server is configured to electronically transmit a notification message to the first computing device indicating that the product is within the predetermined distance of the first computing device.

9. The system of claim 8, wherein the memory of the processing server is further configured to store a delivery location.

10. The system of claim 9, further comprising:
a querying module of the processing server configured to execute a query on the memory to update the delivery location with an updated delivery address, wherein
the transmitting device of the processing server is further configured to electronically transmit an update message to the second computing device, wherein the update message includes the updated delivery address.

11. The system of claim 10, wherein the updated delivery address is the first geographic location.

12. The system of claim 10, wherein the receiving device of the processing server is further configured to receive a location update notification from the first computing device, wherein the location update notification includes the updated delivery address.

13. The system of claim 9, wherein
the calculation module of the processing server is further configured to calculate, after each time interval, a distance between the delivery location and the second geographic location,
receipt of the first location notification and second location notification after subsequent time intervals is repeated if the calculated distance between the first geographic location and the second geographic location and the calculated distance between the delivery location and the second geographic location is greater than the predetermined distance, and
the notification message indicates that the product is within the predetermined distance of the delivery location if the calculated distance between the delivery location and the second geographic location is less than the calculated distance between the first geographic location and the second geographic location.

14. The system of claim 8, wherein
the first location notification is received from the first computing device, and
the second location notification is received from the second computing device.
